(19) United States
(12) Patent Application Publication
(10) Pub. No.: US 2025/0077550 A1
(43) Pub. Date: Mar. 6, 2025

(54) SEARCH DEVICE, SEARCH SYSTEM, SEARCH METHOD, AND RECORDING MEDIUM

(71) Applicant: CASIO COMPUTER CO., LTD., Tokyo (JP)

(72) Inventor: Masahiro ITO, Tokyo (JP)

(73) Assignee: CASIO COMPUTER CO., LTD., Tokyo (JP)

(21) Appl. No.: 18/818,566

(22) Filed: Aug. 28, 2024

(30) Foreign Application Priority Data
Aug. 29, 2023 (JP) 2023-138485

(51) Int. Cl. G06F 16/332; G06F 16/338

(52) U.S. Cl. CPC G06F 16/3323; G06F 16/338

(57) ABSTRACT

A search device includes a control unit performing: causing a display unit to display a list of index words that have been previously used by a user to search for dictionary contents; when the user selects an index word in the list of index words that are being displayed in the display unit, identifying one or more dictionary contents that contain detailed information for the selected index word from among contents of a plurality of types of dictionaries; and causing the display unit to display a search result that includes information indicating the identified one or more dictionary contents and the selected index word associated with the detailed information in each of the identified one or more dictionary contents.

### BACKGROUND OF THE INVENTION

### Technical Field

The present disclosure relates to a search device, a search system, a search method, and a recording medium.

### Background Art

### Related Art Document

One of the functions of an electronic dictionary is to display index words frequently searched by users as a search history. For example, Japanese Laid-Open Patent Publication No. 2006-228044 discloses a technique for displaying the number of searches together with index words as a search history.

### SUMMARY OF THE INVENTION

### Effect of the invention

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a search device comprising a control unit performing the following: causing a display unit to display a list of index words that have been previously used by a user to search for dictionary contents; when the user selects an index word in the list of index words that are being displayed in the display unit, identifying one or more dictionary contents that contain detailed information for the selected index word from among contents of a plurality of types of dictionaries; and causing the display unit to display a search result that includes information indicating the identified one or more dictionary contents and the selected index word associated with the detailed information in each of the identified one or more dictionary contents.

In another aspect, the present disclosure provides a search system including a search device and a server communicably connected to the search device, wherein a control unit of a search device causes a display unit to display a list of index words that have been previously used by a user to search for dictionary contents, wherein when the user selects an index word in the list of index words that are being displayed in the display unit, the control unit of the search device sends the selected index word to the server, wherein a control unit of the server performs the following: identifying one or more dictionary contents that contain detailed information for the selected index word received from the search device from among contents of a plurality of types of dictionaries available through the server; and sending a search result that includes information indicating the identified one or more dictionary contents and the selected index word associated with the detailed information in each of the identified one or more dictionary contents, and wherein the control unit of the search device further causes the display unit of the search device to display the search result received from the server.

In another aspect, the present disclosure provides a search method performed by a computer, comprising: causing a display unit of the computer to display a list of index words that have been previously used by a user to search for dictionary contents; when the user selects an index word in the list of index words that are being displayed in the display unit, identifying one or more dictionary contents that contain detailed information for the selected index word from among contents of a plurality of types of dictionaries; and causing the display unit of the computer to display a search result that includes information indicating the identified one or more dictionary contents and the selected index word associated with the detailed information in each of the identified one or more dictionary contents.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a diagram illustrating a configuration example of a search system according to an embodiment of the present invention.

FIG. 2 is a block diagram illustrating an example of user data stored in the storage unit of the web system.

FIG. 3 is a diagram illustrating an example of an index word integrated search history.

FIG. 4 is a block diagram illustrating a configuration example of a learning terminal.

FIG. 5 is a block diagram illustrating a configuration example of an electronic dictionary.

FIG. 6 is a sequence diagram illustrating an example of an index word search method using a learning terminal.

FIG. 7 is a sequence diagram illustrating an example of an index word search method using an electronic dictionary.

FIG. 8 is a diagram illustrating a first example of screen transitions when searching using an index word list generated based on the index word integrated search history.

FIG. 9 is a flowchart illustrating an example of detailed information display processing.

FIG. 10 is a diagram illustrating an example of screen transitions when displaying detailed information from the search result screen.

FIG. 11 is a diagram illustrating a second example of screen transitions when searching using an index word list generated based on the index word integrated search history.

### DETAILED DESCRIPTION OF EMBODIMENTS

Embodiments of the present disclosure will be described below with reference to the drawings.

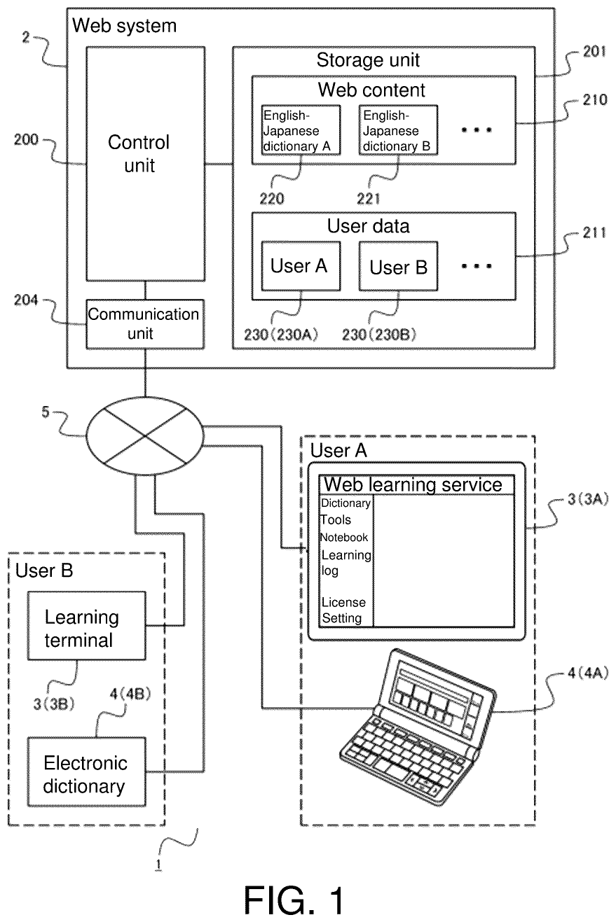

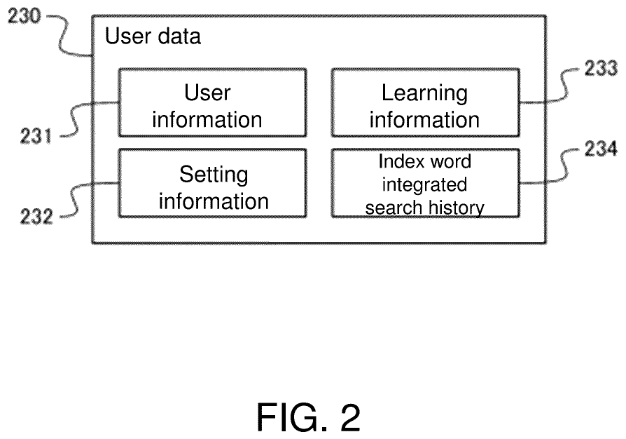

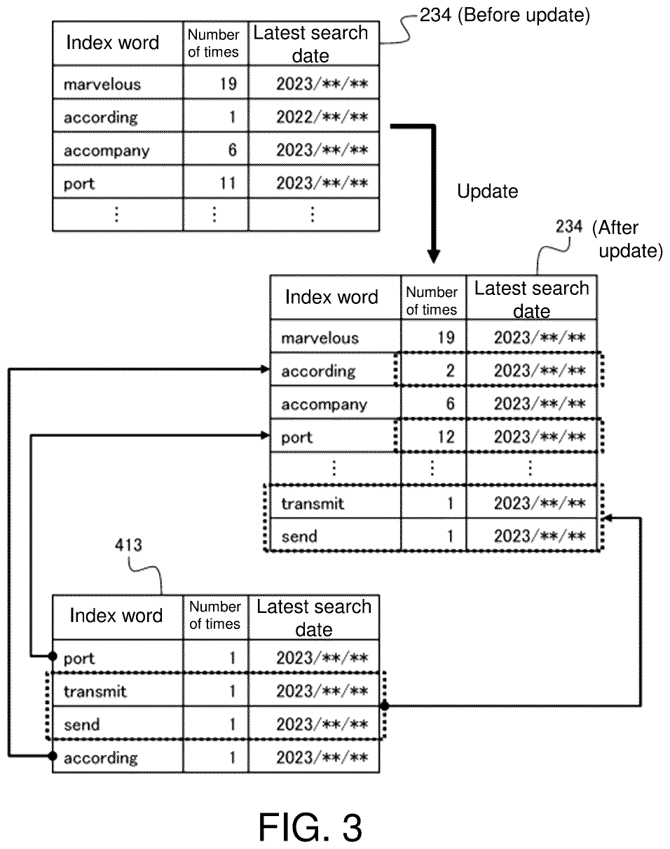

FIG. 1 is a diagram illustrating a configuration example of a search system according to an embodiment. FIG. 2 is a block diagram illustrating an example of user data stored in the storage unit of the Web system. FIG. 3 is a diagram illustrating an example of an index word integrated search history.

The search system 1 illustrated in FIG. 1 includes a Web system 2, a learning terminal 3 as a search device, and an electronic dictionary 4. FIG. 1 shows, as examples of the learning terminal 3 and electronic dictionary 4, a learning terminal 3A and an electronic dictionary 4A used by user A for searching, and a learning terminal 3B and an electronic dictionary 4B used by user B for searching. The search system 1 may include a learning terminal 3 and an electronic dictionary 4 that are used by users other than users A and B for searching. The user may be a child, student, student, etc. In the following description, the learning terminals and electronic dictionaries are referred to using reference numerals “3” and “4” followed by the alphabet “A” or “B” only when specifying the respective users.

The Web system 2 is a system that provides a plurality of content including a plurality of types of English-Japanese dictionaries using the Internet 5, and includes a control section 200, a storage section 201, and a communication section 204. The Web system 2 may be configured by, for example, a single server or a plurality of servers. For example, the web system 2 may be configured with a web server, an application server, and a database server. The term “server” in this specification may be replaced with “computer”.

The control unit 200 controls the operation of the Web system 2. For example, the control unit 200 performs processing according to an HTTP (Hypertext Transfer Protocol) request from the learning terminal 3, generates a screen according to the result of the processing, and transmits it to the learning terminal 3. Processing in response to an HTTP request includes a search process using an index word as a search key, and a process of generating an index word list. The functions of the control unit 200 are provided by one or more processors that execute OS (Operating System) programs and various programs related to content provision. The processor can include a CPU (Central Processing Unit). The processor may include a DSP (Digital Signal Processor) or the like.

The storage unit 201 includes a web content storage area 210 that stores content provided to users via the Internet 5, a user data storage area 211 that stores user data, and a storage area that stores other data, programs, etc. (not shown). The storage device that provides the function of the storage unit 201 includes a ROM (Read Only Memory) and a RAM (Random Access Memory) as a main storage device, and an auxiliary storage device. The auxiliary storage device may be, for example, an HDD (Hard Disk Drive), an SSD (Solid State Drive), or the like. The storage unit 201 may include a portable recording medium as one of the auxiliary storage devices or separate from the main storage device and the auxiliary storage device. The portable recording medium may be an optical disc such as a CD-ROM (Compact Disc-ROM), a DVD (Digital Versatile Disc), a Blu-ray Disc (registered trademark), a storage device having an USB (Universal Serial Bus) terminal, or a card-type storage device and the like. Alternatively, the web system 2 may be connected to the Internet 5 or another network, and the Web system 2 may be able to access the storage unit 201 via the Internet 5 or other network. The Web system 2 records information in the storage unit 201 and reads information recorded in the storage unit 201.

The Web content storage area 210 stores content of multiple types of dictionaries, including content 220 of English-Japanese dictionary A and content 220 of English-Japanese dictionary B. Although not shown in FIG. 1, the content of the English-Japanese dictionary C and the content of the English-Japanese dictionary D are also stored in the Web content storage area 210. Content stored in the Web content storage area 210 is not limited to dictionary content such as an English-Japanese dictionary. The content of these dictionaries include index words and detailed information. In the case of the content of an English-Japanese dictionary, the index word may be an English word, and the detailed information may be information such as the pronunciation symbol of the English word, its meaning in Japanese, and/or an example sentence.

The user data storage area 211 stores user data 230 associated with users who can use the Web system 2, including user data 230A associated with user A and user data 230B associated with user B. In the following description, the reference numerals of user data is a numerical numeral “230” followed by the alphabet “A” or “B” only when specifying a corresponding user.

For example, as shown in FIG. 2, the single user data 230 includes user information 231, setting information 232, learning information 233, and index word integrated search history 234.

User information 231 includes various information regarding users associated with user data 230. The user information 231 includes, for example, information such as a license granted to a user to permit use of the Web system 2, a user name, and a password. The setting information 232 includes various setting information regarding how the user uses the content and the like. The setting information 232 includes, for example, information regarding the design and layout of the screen displayed on the learning terminal 3 when the learning terminal 3 is connected to the Web system 2, information regarding the conditions for searching for index words, etc. Either the user information 231 or the setting information 232 may also include information for identifying the search device (learning terminal 3 and electronic dictionary 4) used by the user for searching, such as the serial number of the search device, hardware configuration, etc.

The learning information 233 includes information related to the learning performed by the user by connecting the learning terminal 3 to the Web system 2, such as markers, sticky notes, etc. that are electronically attached by the user to detailed information of words looked up using dictionary content.

The index word integrated search history 234 is an index word search history in which the index words searched by the user by connecting the learning terminal 3 to the Web system 2 and the index words searched in the electronic dictionary 4 are integrated. For example, as shown in FIG. 3, the index word integrated search history 234 records the number of searches and the latest search date for each searched index word. When a user uses the learning terminal 3 to search for a certain index word in a single dictionary, for example, the control unit 200 of the Web system 2 updates the index word integrated search history 234. If the searched index word is included in the index word integrated search history 234, the control unit 200 updates the number of times the index word has been searched and the latest search date, and if it is not included in the index word integrated search history 234, the control unit 200 adds the index word itself, the number of times it has been searched, and the latest search date to the index word integrated search history 234. Furthermore, as shown in FIG. 3, for example, when an index word search history 413 is acquired from the electronic dictionary 4 used by the user, the control unit 200 updates the index word integrated search history 234 based on information on the searched index words, the number of times the index words have been respectively searched, and the latest search date contained in the index word search history 413.

For example, the index words “port” and “according” in the index word search history 413 shown in FIG. 3 are included in the index word integrated search history 234 before updating. Therefore, the control unit 200 updates the number of searches and the latest search date for each of the index words “port” and “according” in the index word integrated search history 234. Further, if the index words “transmit” and “send” in the index word search history 413 illustrated in FIG. 3 are not included in the index word integrated search history 234 before updating, the control unit 200 adds the index words “transmit” and “send” and the number of searches and latest search date for each index word.

Returning to the description of the configuration example of the Web system 2 with reference to FIG. 1, the communication unit 204 of the Web system 2 connects the Web system 2 to the Internet 5 and performs communication with external devices via the Internet 5. The functions of the communication unit 204 are provided by a communication device that is connected to a communication device such as a router connected to the Internet 5 through a transmission cable such as a LAN (Local Area Network) cable, and that performs communication according to a well-known communication standard. The functions of the communication unit 204 may be provided, for example, by a wireless communication device that wirelessly communicates with a communication device such as an access point or router connected to the Internet 5 in accordance with a wireless communication standard such as Wi-Fi (registered trademark).

Although not shown in FIG. 1, the Web system 2 may include, for example, an input section provided by an input device such as a keyboard or a mouse, a display section provided by a display device such as a liquid crystal display, and the like.

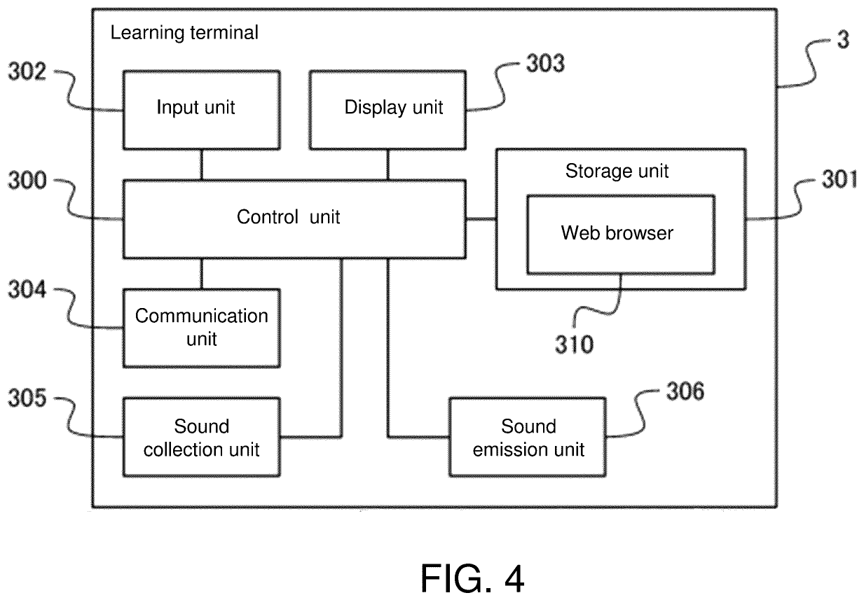

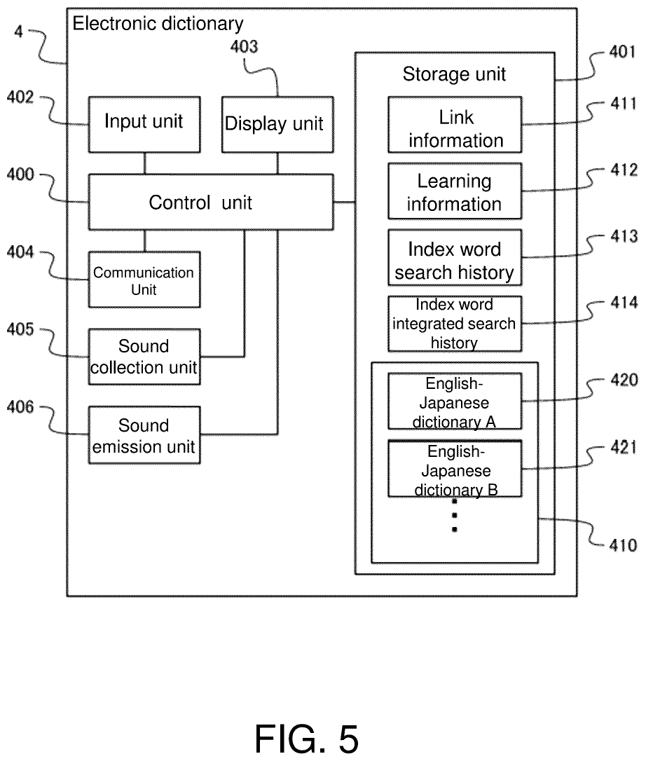

Next, a configuration example of the learning terminal 3 and the electronic dictionary 4 will be explained. FIG. 4 is a block diagram illustrating a configuration example of a learning terminal. FIG. 5 is a block diagram illustrating a configuration example of an electronic dictionary.

The learning terminal 3 illustrated in FIG. 4 includes a control unit 300, a storage unit 301, an input unit 302, a display unit 303, a communication unit 304, a sound collection unit 305, and a sound emission unit 307. The learning terminal 3 may be, for example, a personal computer such as a tablet computer. The learning terminal 3 is not limited to a general-purpose computer, but may be a computer dedicated to learning using the Web system 2 or a computer with limited functions. The appearance of the learning terminal 3 is not limited to the appearance of the learning terminal 3A illustrated in FIG. 1.

The control unit 300 controls the operation of the learning terminal 3. The control unit 300 performs, for example, a process of displaying a screen transmitted from the Web system 2 on a web browser, a process of transmitting information input on the web browser to the Web system 2 as an HTTP request, and the like. The functions of the control unit 300 are provided by one or more processors that execute an OS program and various programs (such as a Web browser 310) related to the use of content of the Web system 2. The processor can include a CPU. The processor may include a DSP or the like.

The storage unit 301 has a storage area for storing the Web browser 310 and a storage area for storing other data, programs, etc. (not shown). The Web browser 310 is not limited to a specific browser as long as it can view and operate dictionary content provided by the Web system 2, and input characters and the like. A storage device that provides the function of the storage unit 301 includes a ROM and a RAM as a main storage device, and an auxiliary storage device. The auxiliary storage device may be, for example, an HDD, an SSD, or the like. The storage unit 301 may include a portable recording medium such as an optical disc, a storage device equipped with a USB terminal, or a card-type storage device.

The input unit 302 receives input of information regarding the operation (movement) of the learning terminal 3. Inputs accepted by the input unit 302 include inputs for starting the Web browser 310, inputs for selecting objects displayed on the Web browser, inputs for index words, and the like. The functions of the input unit 302 are provided by, for example, a keyboard, a mouse, or the like. The display unit 303 visualizes and displays information regarding the operation of the learning terminal 3 and the like. The information displayed on the display unit 303 includes information on the Web browser screen transmitted from the Web system 2. The functions of the display unit 303 are provided by, for example, a display device such as a liquid crystal display. When the learning terminal 3 is a terminal equipped with a touch panel display such as a tablet computer, part or all of the functions of the input unit 302 are provided by a position detection device superimposed on the display surface of a display device functioning as the display unit 303.

The communication unit 304 connects the learning terminal 3 to the Internet 5 and performs communication with external devices via the Internet 5. The functions of the communication unit 304 are provided, for example, by a wireless communication device that wirelessly communicates with an access point or router connected to the Internet 5 in accordance with a wireless communication standard such as Wi-Fi or Bluetooth (registered trademark). The functions of the communication unit 304 may be provided by a communication device connected to a communication device such as a router connected to the Internet 5 via a transmission cable such as a LAN cable.

The sound collection unit 305 converts sounds (sound waves) around the learning terminal 3 into audio data (electrical signals). The sound collection unit 305 enables, for example, pronunciation practice by the user using content, operation input by voice, etc. The function of the sound collection unit 305 is provided, for example, by a microphone built into the learning terminal 3 or connected to an input terminal equipped in the learning terminal 3. The sound emission unit 306 emits audio data (electrical signals) as sound (sound waves) around the learning terminal 3. The sound emission unit 306 enables pronunciation and listening practice by the user using content, operation guidance by voice, etc. The function of the sound emission unit 306 is provided, for example, by a speaker built into the learning terminal 3. The function of the sound emission unit 306 may be provided by earphones, speakers, etc., connected to an output terminal equipped in the learning terminal 3.

The electronic dictionary 4 shown in FIG. 5 includes a control unit 400, a storage unit 401, an input unit 402, a display unit 403, a communication unit 404, a sound collection unit 405, and a sound emission unit 406. The electronic dictionary 4 may be an electronic device specialized in providing multiple types of content including some or all of the multiple types of content provided by the Web system 2. The multiple types of content provided by the electronic dictionary 4 may include content other than a dictionary, or may include content not provided by the Web system 2. The appearance of the electronic dictionary 4 is not limited to the appearance of the electronic dictionary 4A illustrated in FIG. 1.

The control unit 400 controls the operation of the electronic dictionary 4. The control unit 400 performs, for example, a process of searching the dictionary for an input index word and displaying the search results, a process of communicating with the Web system 2 and updating the index word integrated search history, etc. The functions of the control unit 400 are provided by a processor that executes an OS program, various programs related to the use of content stored (contained) in the storage unit 401, and various programs related to communication (linkage) with the Web system 2. The processor may include a CPU.

The storage unit 401 has a content storage area 410 for storing a plurality of types of content, a storage area for storing each of link information 411, learning information 412, index word search history 413, and index word integrated search history 414, and a storage area for storing other data, programs, etc. (not shown). The storage device providing the functions of the storage unit 401 includes a ROM and a RAM. Some of the functions of the storage unit 401 may be provided by a portable recording medium such as a card-type storage device, for example.

The multiple types of content stored in the content storage area 410 include content 420 of English-Japanese dictionary A and content 421 of English-Japanese dictionary B shown in FIG. 5, as well as one or more contents not shown in FIG. 5. The combination of content provided by the electronic dictionary 4 may be the same as or different from the combination of content provided by the Web system 2. For example, if the Web system 2 provides content of English-Japanese dictionary D, the multiple types of content provided by the electronic dictionary 4 may or may not include the content of English-Japanese dictionary D. In addition, the multiple types of content provided by the electronic dictionary 4 may include content that is not provided by the Web system 2.

The link information 411 stores information used for linking a search history with the index word integrated search history 234 (see FIG. 2) in the user data of the Web system 2. The link information 411 includes, for example, information such as the serial number and hardware configuration of the electronic dictionary 4 used for matching with the user information 231 or the setting information 232 (see FIG. 2) of the user data 230 in the Web system 2.

The learning information 412 includes information related to the learning the user has performed using the electronic dictionary 4, such as markers, sticky notes, memos, and other information electronically attached to detailed information on words looked up using the dictionary content.

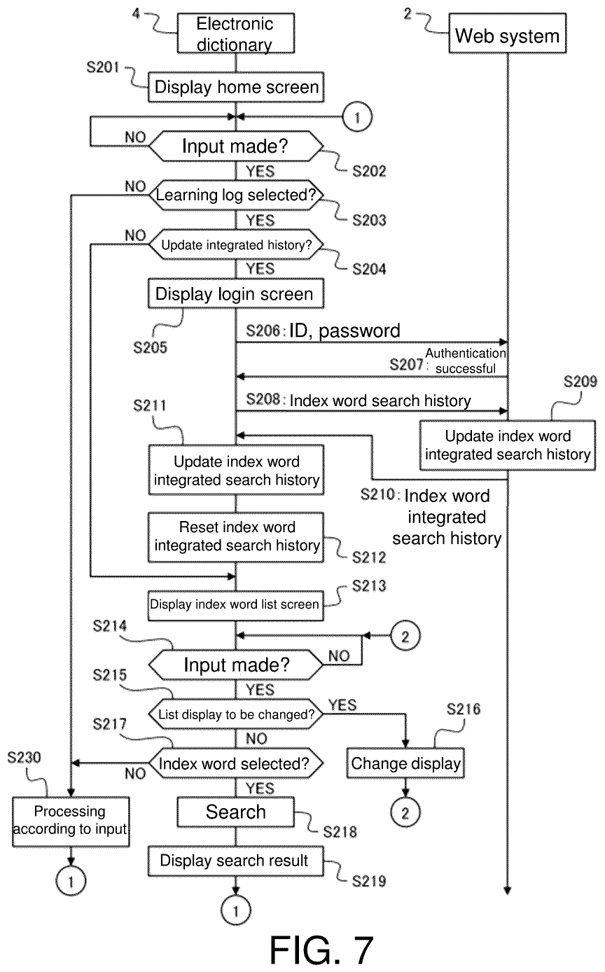

The index word search history 413 includes a search history of index words searched for by the user in the electronic dictionary 4. For example, as shown in FIG. 3, the index word search history 413 records the number of searches and the most recent search date for each index word searched for in the electronic dictionary 4. The index word integrated search history 414 corresponds to the index word integrated search history 234 included in the user data 230 of the Web system 2. As will be described later with reference to FIG. 7, the electronic dictionary 4 transmits the index word search history 413 to the Web system 2, acquires the index word integrated search history 234 updated on the Web system 2 based on the index word search history 413 from the Web system 2, and updates the index word integrated search history 414.

The input unit 402 accepts input of information relating to the operation (movement) of the electronic dictionary 4. The input accepted by the input unit 402 includes input for selecting content, input of index words, etc. The function of the input unit 402 is provided by, for example, a keyboard, etc. The display unit 403 visualizes and displays information relating to the operation, etc., of the electronic dictionary 4. The information displayed by the display unit 403 includes information on a content selection screen, information on an index word input screen, and information on a screen of search results for index words. The function of the display unit 403 is provided by, for example, a display device such as a liquid crystal display. If the electronic dictionary 4 is a device equipped with a touch panel display, some or all of the function of the input unit 402 includes a position detection device arranged over the display surface of a display device functioning as the display unit 403.

The communication unit 404 connects the electronic dictionary 4 to the Internet 5 and communicates with an external device via the Internet 5. The function of the communication unit 404 is provided by a wireless communication device that performs wireless communication with an access point or a router connected to the Internet 5 in accordance with a wireless communication standard such as Wi-Fi or Bluetooth. The function of the communication unit 404 may be provided by an input/output interface that is connected to a computer connected to the Internet 5 via a transmission cable such as a USB cable.

The sound collection unit 405 converts sounds (sound waves) around the electronic dictionary 4 into audio data (electrical signals). The sound collection unit 405 enables, for example, the user to practice pronunciation using content, perform input operations by voice, etc. The function of the sound collection unit 405 is provided, for example, by a microphone built into the electronic dictionary 4 or connected to an output terminal of the electronic dictionary. The sound emission unit 406 emits audio data (electrical signals) as sound (sound waves) around the electronic dictionary 4. The sound emission unit 406 enables the user to practice pronunciation and listening using content, provide operation guidance by voice, etc. The function of the sound emission unit 406 is provided, for example, by a speaker built into the electronic dictionary 4. The function of the sound emission unit 406 may be provided by earphones, speakers, etc., connected to an output terminal of the electronic dictionary 4.

The learning terminal 3 and the electronic dictionary 4 in the search system 1 according to an embodiment of the present invention are not limited to the above-mentioned configurations. For example, some or all of the functions of the control unit 400 and the storage unit 401 in the electronic dictionary 4 may be provided by a Field Programmable Gate Array (FPGA), a Programmable Logic Device (PLD), an Application Specific Integrated Circuit (ASIC), or the like.

As described above, the users of the search system 1 according to an embodiment of the present invention may be children, pupils, students, etc. A single user can use either the learning terminal 3 or the electronic dictionary 4 depending on the learning environment. For example, when looking up the meaning of an English word in an English-Japanese dictionary, the user can use the learning terminal 3 during class at school and the electronic dictionary 4 during independent study at home. Looking up the meaning of an English word using the Web system 2 or the content of the English-Japanese dictionary in the electronic dictionary 4 is an example of searching for an index word.

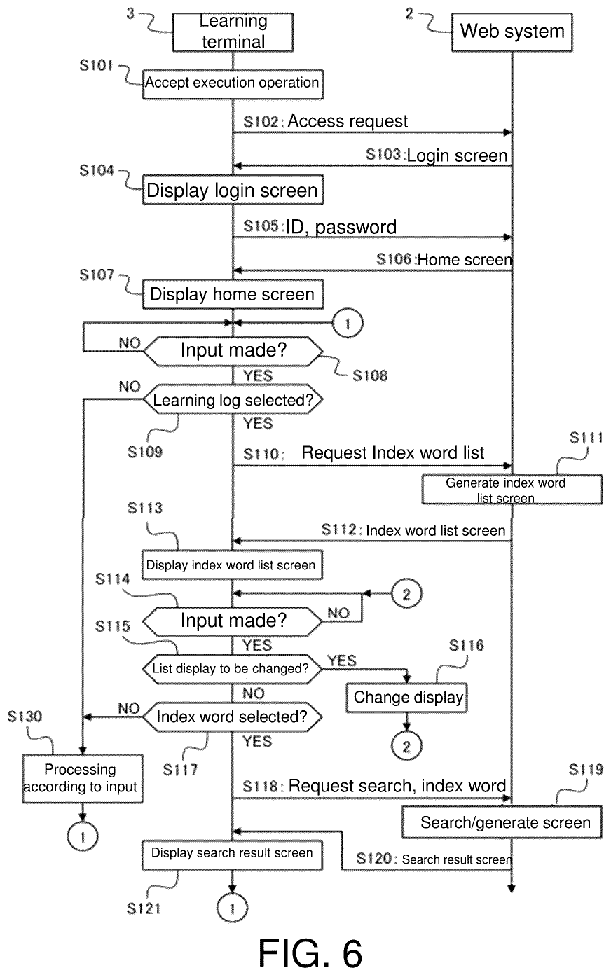

FIG. 6 is a sequence diagram for explaining an example of a method for searching for an index word using a learning terminal. The process performed by the leaning terminal 3 illustrated in FIG. 6 is performed by the control unit 300 of the learning terminal 3 alone or in cooperation with the storage unit 301, the input unit 302, the display unit 303, the communication unit 304, etc. The process performed by the Web system 2 illustrated in FIG. 6 is performed by the control unit 200 of the Web system 2 alone or in cooperation with the storage unit 201, the communication unit 204, etc.

When searching for an index word using the learning terminal 3, first, the learning terminal 3 is connected to the Web system 2, and a process of displaying a home screen on the learning terminal 3 is performed (Steps S101 to S107). To connect the learning terminal 3 to the Web system 2, the user, for example, double-clicks a specific icon displayed on the display unit 303 of the learning terminal 3, or performs an operation to access the Web system 2 on the displayed Web browser. When this operation is accepted (Step S101), the learning terminal 3 transmits an access request to the Web system 2 (Step S102). At this time, if the Web browser is not activated, the learning terminal 3 activates the Web browser. The access request may be a well-known HTTP request.

When the Web system 2 that has received the access request returns login screen data (Web page) to the learning terminal 3 as an HTTP response (Step S103), the login screen is displayed on the Web browser of the learning terminal 3 (Step S104). When the user inputs an ID (user name) and password into the text fields of the login screen displayed on the Web browser and presses the login execution button, the learning terminal 3 encodes the inputted ID and password and transmits them to the Web system 2 (Step S105).

The Web system 2 that has received the encoded ID and password information decodes the ID and password from the received information and performs authentication, although this is not shown in FIG. 6. If the authentication is successful, the Web system 2 transmits home screen data to the learning terminal 3 (Step S106), and the home screen is displayed on the Web browser of the learning terminal 3 (Step S107). If the authentication is unsuccessful, the Web system 2 transmits to the learning terminal 3 data of a login screen that prompts the user to resend the ID and password, although this is not shown in FIG. 6.

After displaying the home screen on the web browser, the learning terminal 3 continues to judge whether or not there is an input until an input is made to the learning terminal 3 (Step S108; NO). When an input is made (Step S108; YES), the learning terminal 3 judges whether or not the input is an input for selecting a learning log (Step S109). In this specification, the term “learning log” is the name of an item for selecting the display of an entry list based on the index word integrated search history 234 or 414. If the input is not an input for selecting the learning log (Step S109; NO), the learning terminal 3 performs a process according to the input that is different from the process performed when the learning log is selected (Step S130), and then returns to the judgment of Step S108. The process performed by the learning terminal 3 in Step S130 may be, for example, a process for displaying the top screen of the selected content, a process for displaying a screen of the search results for the index word input in the text field, or the like. Step S130 includes a process of sending an HTTP request according to the input to the Web system 2, and a process of displaying on the Web browser screen data as an HTTP response from the Web system 2. When the process of displaying the search result screen is performed in Step S130, the Web system 2 updates the index word integrated search history 234 in the user data 230 associated with the user of the learning terminal 3.

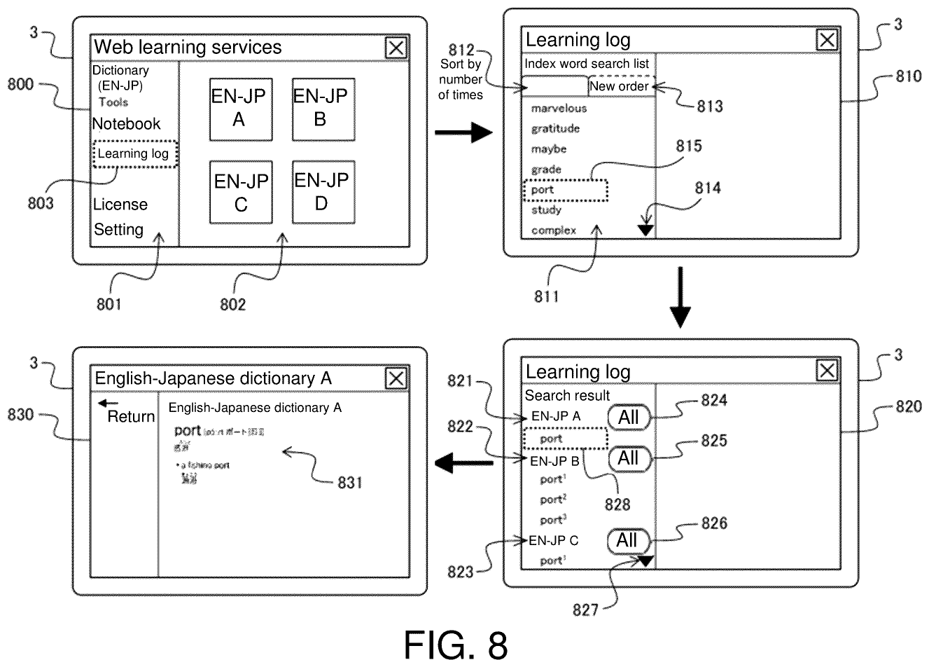

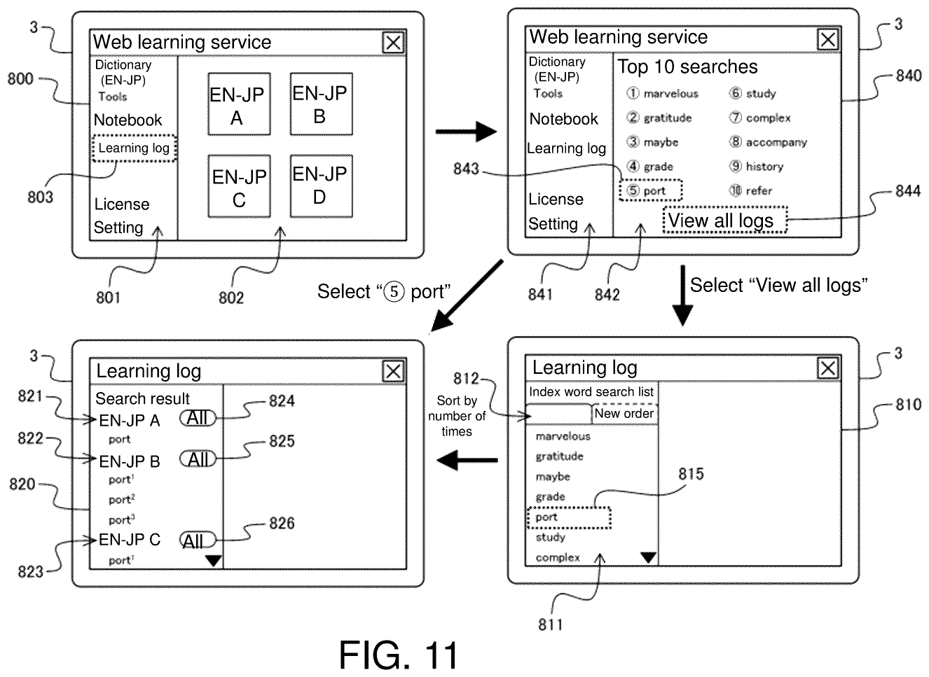

When an input for selecting the learning log is made (Step S109; YES), the learning terminal 3 transmits an HTTP request for requesting an index word list to the Web system 2 (Step S110). The Web system 2 that has received this HTTP request generates data for an index word list screen based on the index word integrated search history 234 (Step S111). After that, data for the index word list screen is transmitted from the Web system 2 to the learning terminal 3 (Step S112), and the index word list screen is displayed on the Web browser of the learning terminal 3 (Step S113). The index word list screen may be, for example, a screen in which all index words in the index word integrated search history 234 are arranged in descending order of search frequency, such as the index word list screen 810 shown in FIG. 8. The index word list screen may be, for example, a screen in which the top 10 index words in the index word integrated search history 234 are arranged in descending order of search frequency, such as the index word list screen 840 shown in FIG. 11. Information for specifying the display method of the index words on the index word list screen generated in Step S111 may be included in the setting information 232 of the user data 230, for example.

After displaying the index word list screen on the Web browser, the learning terminal 3 continues to judge whether or not there is an input until an input is made to the learning terminal 3 (Step S114; NO). When an input is made (Step S114; YES), the learning terminal 3 judges whether or not the input is an input for selecting a change in the display method of the index word list (Step S115). If the input is an input for selecting a change in the display method of the index word list (Step S115; YES), the learning terminal 3 displays the index word list screen in which the display method of the index word list has been changed (Step S116), and returns to the judgment of Step S114. Although omitted in FIG. 6, when the learning terminal 3 performs the process of Step S116, the learning terminal 3 transmits an HTTP request including information indicating that the display method of the index word list is to be changed to the Web system 2, and acquires the index word list screen in which the display method has been changed from the Web system 2.

If the input is not for selecting a change in the display method of the index word list (Step S115; NO), the learning terminal 3 judges whether or not the input is for selecting an index word in the index word list screen (Step S117). If the input is not for selecting an index word (Step S117; NO), the learning terminal 3 performs a process according to the input (Step S130), and then returns to the judgment of Step S108.

If the input is for selecting an index word (Step S117; YES), the learning terminal 3 transmits an HTTP request to the Web system 2 requesting a search using the index word as a search key (Step S118). The Web system 2 that has received this HTTP request searches the content of multiple dictionaries using the index word included in the request as a search key, and generates a search result screen showing the search results (Step S119). In step S119, the Web system 2 identifies the content of a dictionary that includes detailed information about the index word used as the search key from among the content of the multiple dictionaries, and generates a search result screen including information indicating the identified dictionary. After that, data of the search result screen is transmitted from the Web system 2 to the learning terminal 3 (Step S120), and the search result of the selected index word is displayed on the Web browser of the learning terminal 3 (Step S121). In Step S119, when there are two or more types of dictionaries that include detailed information about the index word, the Web system 2 generates data of a search result screen that includes information indicating each of the dictionaries including the detailed information. For example, if detailed information for a certain index word is written in English-Japanese dictionary A and English-Japanese dictionary B, the search result screen generated by the Web system 2 includes information indicating English-Japanese dictionary A and information for the index word in English-Japanese dictionary A, as well as information indicating English-Japanese dictionary B and information for the index word in English-Japanese dictionary B. Specific examples of the search result screen will be described later with reference to FIGS. 8 and 11.

Next, an example of a method for searching for an index word using the electronic dictionary 4 will be described with reference to FIG. 7. FIG. 7 is a sequence diagram for explaining an example of a method for searching for an index word using an electronic dictionary. The process performed by the electronic dictionary 4 illustrated in FIG. 7 is performed by the control unit 400 of the electronic dictionary 4 alone or in cooperation with the storage unit 401, the input unit 402, the display unit 403, the communication unit 404, etc. Also, the process performed by the Web system 2 illustrated in FIG. 7 is performed by the control unit 200 of the Web system 2 alone or in cooperation with the storage unit 201, the communication unit 204, etc.

When the power supply of the electronic dictionary 4 is turned on, the electronic dictionary 4 displays a home screen on the display unit 403 (Step S201). After displaying the home screen, the electronic dictionary 4 continues to judge whether or not an input is made until an input is made (Step S202; NO). When an input is made (Step S202; YES), the electronic dictionary 4 judges whether or not the input is an input for selecting the learning log (Step S203). If the input is not an input for selecting the learning log (Step S203; NO), the electronic dictionary 4 performs a process according to the input that is different from the process performed when the learning log is selected (Step S230), and then returns to the judgment of Step S202. The process performed by the electronic dictionary 4 in step S230 may be, for example, a process for displaying a top screen of the selected content, a process for searching for an index word entered in a text field and displaying a screen of the search results, etc. When the search result screen is displayed in Step S230, the electronic dictionary 4 updates, for example, the index word search history 413 and the index word integrated search history 414 in the storage unit 401.

When an input for selecting the learning log is made (Step S203; YES), the electronic dictionary 4 next judges whether or not it is time to update the index word integrated search history 234 of the Web system 2 (Step S204). The electronic dictionary 4 judges that it is time to update when the detected “input for selecting the learning log” is, for example, the first input made within a predetermined period including the day on which the input was made. The predetermined period may be only the day on which the input was made, or may be a period of two or more days. When it is not time to update (Step S204; NO), the electronic dictionary 4 omits the process for updating the index word integrated search history 234, and generates and displays an index word list screen based on the index word integrated search history 414 in the storage unit 401 (Step S213). The index word list screen displayed in Step S213 may be, for example, a screen similar to the index word list screen 810 shown in FIG. 8 or the index word list screen 840 shown in FIG. 11.

If it is time to update the index word integrated search history 234 of the Web system 2 (Step S204; YES), the electronic dictionary 4 displays a login screen for connecting to the Web system 2 (Step S205). When the user inputs an ID (user name) and password into the text fields of the login screen and presses a button to execute login, the electronic dictionary 4 encodes the inputted ID and password and transmits them to the Web system 2 (Step S206).

The Web system 2 that has received the encoded ID and password information decodes the ID and password from the received information and performs authentication, although this is not shown in FIG. 7. If the authentication is successful, the Web system 2 transmits information indicating that the authentication is successful to the electronic dictionary 4 (Step S207). If the authentication is successful, the electronic dictionary 4 transmits the index word search history 413 to the Web system 2 (Step S208). The Web system 2 that has received the index word search history 413 from the electronic dictionary 4 updates the index word integrated search history 234 of the user data 230 associated with the user of the electronic dictionary 4 based on the index word search history 413 (Step S209), and transmits the updated index word integrated search history 234 to the electronic dictionary 4 (Step S210). The electronic dictionary 4 that has received the updated index word integrated search history 234 from the Web system 2 updates (replaces) the index word integrated search history 414 in the storage unit 401 with the received index word integrated search history 234 (Step S211). After successfully updating the index word integrated search history 234 of the Web system 2 and the index word integrated search history 414 of the storage unit 401, the electronic dictionary 4 resets the index word search history 413 of the storage unit 401 (Step S212). After that, the electronic dictionary 4 generates and displays an index word list screen based on the updated index word integrated search history 414 (Step S213). In Step S212, the electronic dictionary 4 erases, for example, information for the index words, the number of searches, and the latest search date recorded in the index word search history 413. If updating the index word integrated search history 234 of the Web system 2 and the index word integrated search history 414 of the storage unit 401 fails, the electronic dictionary 4 does not need to perform the process of Step S212.

After displaying the index word list screen, the electronic dictionary 4 continues to judge whether or not there is an input until an input is made to the electronic dictionary 4 (Step S214; NO). When an input is made (Step S214; YES), the electronic dictionary 4 judges whether or not the input is an input for selecting a change in the display method of the index word list (Step S215). If the input is an input for selecting a change in the display method of the index word list (Step S215; YES), the electronic dictionary 4 displays the index word list screen in which the display method of the index word list has been changed (Step S216), and returns to the judgment of Step S214.

If the input is not for selecting a change in the display method of the index word list (Step S215; NO), the electronic dictionary 4 judges whether the input is for selecting an index word in the index word list screen (Step S217). If the input is not for selecting an index word (Step S217; NO), the electronic dictionary 4 performs a process according to the input (Step S230), and then returns to the judgment of Step S202.

If the input is to select an index word (Step S217; YES), the electronic dictionary 4 searches the content of multiple types of dictionaries in the storage unit 401 using the index word as a search key (Step S218), and generates and displays a search result screen showing the search results (Step S219). After that, the electronic dictionary 4 returns to the determination in Step S202. In Step S219, the electronic dictionary 4 identifies, from the content of multiple types of dictionaries, the content of a dictionary that has detailed information about the index word used as the search key, and generates a search result screen including information for the identified dictionary.

In this way, in the search system 1 of an embodiment of the present invention, the integrated index word search histories 234 and 414 are generated and updated as needed, integrating the search history of index words searched by a single user using the learning terminal 3 and the search history of index words searched by a single user using the electronic dictionary 4. Therefore, when a single user views a list of index words searched in the past using either one of the learning terminal 3 and the electronic dictionary 4, the user can view a list of index words that also reflects the search history of index words searched by the other of the learning terminal 3 and the electronic dictionary 4.

In the search system 1 of an embodiment of the present invention, as described above, when an index word included in the index word list screen displayed on the learning terminal 3 and the electronic dictionary 4 is selected, the content of multiple dictionaries can be searched for using the selected index word as a search key. Therefore, the search result screen for the selected index word can include search results in multiple dictionaries.

FIG. 8 is a diagram illustrating a first example of screen transitions when performing a search using an index word list generated based on an index word integrated search history. FIG. 8 illustrates an example of screen transitions on the learning terminal 3, but the screen transitions on the electronic dictionary 4 may be similar. In FIG. 8, the screens on the learning terminal 3 transition in a clockwise direction starting from a screen 800 shown at the top left.

The screen 800 of the learning terminal 3 at the top left can be a screen for selecting the content of an English-Japanese dictionary. In the screen 800, an area 801 on the left side displays items (menus) related to search, learning, etc. using the Web system 2, and an area 802 on the right side displays icons indicating the content of available English-Japanese dictionaries. By inputting (operating) to select an icon in the area 802, a search can be performed using the selected single English-Japanese dictionary.

When an item 803 of “Learning Log” displayed in the area 801 on the screen 800 is selected, the processes of Steps S110 to S113 described above with reference to FIG. 6 are performed between the learning terminal 3 and the Web system 2. By performing Step S113, the screen displayed on the learning terminal 3 is switched from the screen 800 to the index word list screen 810 illustrated in the learning terminal 3 at the top right. The index word list screen 810 includes an area 811 that displays index words included in the index word integrated search history 234, and tabs 812 and 813 that switch the sorting order of the index words displayed in the area 811. In the index word list screen 810 of FIG. 8, the tab 812 is selected, and a list of index words arranged in descending order of the number of searches is displayed in the area 811. When the tab 813 is selected, the display of the area 811 is switched to a display of a list of index words arranged in descending order of the search date (in other words, in descending order of the most recent search date). In the area 811, for example, a scroll button 814 is displayed, and by pressing the scroll button 814, index words displayed in the area 811 can be switched.

When an index word displayed in the area 811 of the index word list screen 810 is selected, the processes of Steps S118 to S121 described above with reference to FIG. 6 are performed between the learning terminal 3 and the Web system 2. For example, when the index word 815 “port” displayed in the area 811 is selected, the Web system 2 searches a plurality of English-Japanese dictionaries using “port” as a search key and generates a search result screen. When the user selects “port” and Steps S118 to S121 of FIG. 6 are performed, the screen displayed on the learning terminal 3 is switched from the index word list screen 810 to a search result screen 820 illustrated on the learning terminal 3 at the lower right. The search result screen 820 includes dictionary information 821 to 823 indicating English-Japanese dictionaries including detailed information about the index word used as the search key, the index words associated with the detailed information in the English-Japanese dictionaries, and “All” buttons 824 to 826 associated with each of the dictionary information 821 to 823. When all of the information to be displayed as search results cannot be displayed on one screen on the display unit 303 of the learning terminal 3, for example, a scroll button 827 is displayed on the search result screen 820. By pressing the scroll button 827, the search results displayed on the search result screen 820 can be switched.

On the search result screen 820, when any of the index words displayed in association with each of the dictionary information 821 to 823 is selected, the screen displayed on the learning terminal 3 changes to the dictionary associated with the selected index word. The screen switches to a detailed information screen containing detailed information about the index word. For example, if the index word 828 “port” that is associated with the dictionary information 821 “English-Japanese A” is selected, the screen displayed on the learning terminal 3 changes from the search results screen 820 to a detailed information screen 830 that includes detailed information 831 about “port” in the English-Japanese dictionary A, as illustrated in the learning terminal 3 at the bottom left. The detailed information 831 on the detailed information screen 830 includes information on the pronunciation symbol of “port”, part of speech, Japanese meaning, and example sentence. Therefore, by a simple input operation, the user of the learning terminal 3 can display the detailed information screen 830 that includes detailed information on the content of the desired dictionary specified for the index word searched in the past.

In this way, in the search system 1 of an embodiment of the present invention, when detailed information about the index word selected on the index word list screen 810 is included in a plurality of dictionaries, the search result screen 820 that notifies the user of the plurality of dictionaries that include the detailed information is displayed. Therefore, the user of the learning terminal 3 and the electronic dictionary 4 can easily see, from the search result screen 820, dictionaries that include detailed information about the index words searched in the past. The index word selected by the user from the index word list screen 810, which is a form of index word search history, is an index word that has been searched in one or more dictionaries displayed on the search result screen 820. Therefore, the user can easily check the dictionary used to search for the index word from the index word search history.

In addition, if any of the “All” buttons 824 to 826 included in the search result screen 820, which is illustrated in the learning terminal 3 at the bottom right of FIG. 8, is selected, a screen that include all of the detailed information about the selected index word in the dictionary corresponding to the selected button can be generated and displayed.

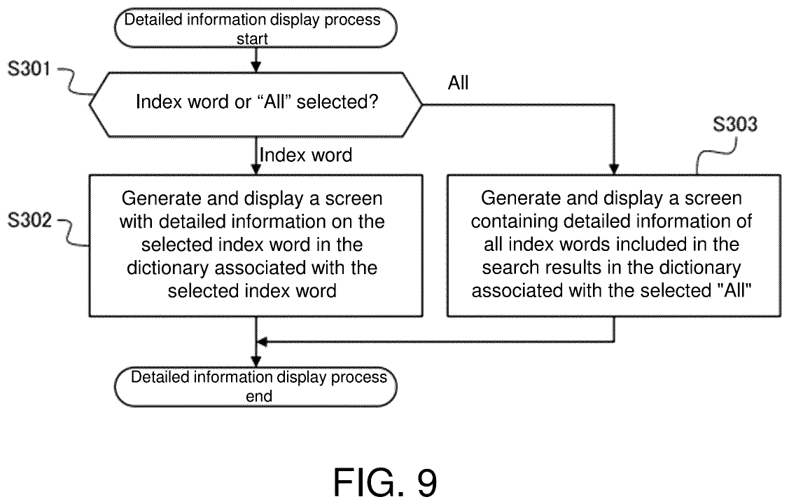

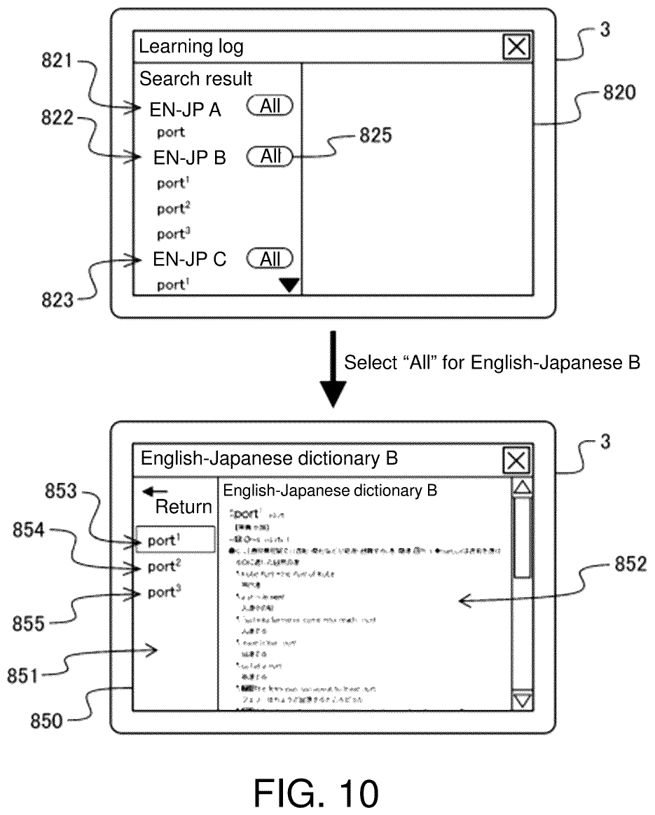

FIG. 9 is a flowchart illustrating an example of a detailed information displaying process. FIG. 10 is a diagram illustrating an example of screen transitions when displaying detailed information from a search result screen. Although the process in FIG. 9 will be described below as a process performed by the learning terminal 3 and the web system 2, the process in FIG. 9 may also be performed by the electronic dictionary 4. Moreover, although FIG. 10 illustrates screen transitions on the learning terminal 3, the screen transitions on the electronic dictionary 4 may be similar.

When the user performs an operation to display detailed information on the learning terminal 3 on which the search result screen 820 is displayed, the search system 1 performs a detailed information displaying process including Steps S301 to S303 illustrated in FIG. 9.

In the detailed information displaying process, first, the control unit 300 of the learning terminal 3 determines which one of an index word and an “All” button on the search result screen 820 is selected (Step S301). When an index word on the search result screen 820 is selected (Step S301; index word), the learning terminal 3 and the web system 2 generate and display a screen containing detailed information of the selected index word in the dictionary associated with the selected index word (Step S302). When an “All” button on the search result screen 820 is selected (Step S301; all), the learning terminal 3 and the web system 2 generate and display a screen containing detailed information of all index words included in the search results of the dictionary associated with the selected “All” button (Step S303).

The process in Step S302 corresponds to, for example, switching from the search result screen 820 at the bottom right in FIG. 8 to the detailed information screen 830 at the bottom left. Although a description with reference to the figures will be omitted, if any of the three index words “port1”, “port2”, and “port3”, which are associated with the dictionary information 822 indicating English-Japanese dictionary B on the search result screen 820 illustrated in FIG. 8 is selected, for example, a screen containing only detailed information about the selected index word in English-Japanese dictionary B (for example, “port2”) is displayed on the learning terminal 3.

The process of Step S303 is performed when the “All” button 825 associated with the dictionary information 822 indicating English-Japanese dictionary B on the search result screen 820 is pressed, as shown in FIG. 10, for example. At this time, a detailed information screen 850 containing detailed information about each of the three “ports” associated with the dictionary information 822 indicating English-Japanese dictionary B is displayed on the screen of the learning terminal 3. In the detailed information screen 850, an area 851 on the left side displays index words 853 to 855 that correspond to the three index words “port1,” “port2,” and “port3” included in English-Japanese dictionary B, and detailed information 852 including detailed information about each of the three index words “port1”, “port2”, and “port3” is displayed in an area on the right side. As illustrated in FIG. 10, if all the detailed information to be displayed cannot be displayed on one screen in the display unit 303 of the learning terminal 3, a scroll bar is displayed on the detailed information screen 850, for example. By pressing the scroll bar, the detailed information displayed within the detailed information screen 850 can be switched. Further, the display of the index words 853 to 855 in the area 851 may be associated with detailed information displayed on the display unit 303, out of the detailed information 852, for example. When detailed information about the first index word 853 among the three index words 853 to 855 is displayed on the display unit 303, for example, the display format of the index word 853 may be set to be different from that of the other index words 854 and 855. Thereby, the user can easily understand that the detailed information displayed on the display section 303 is detailed information about the index word 853. Further, when one of the three index words 853 to 855 displayed in the area 851 is selected, for example, a portion including the beginning of detailed information about the selected index word may be displayed on the display unit 303.

Furthermore, when generating the search result screen 820, an upper limit on the number of index words in one dictionary may be set. For example, on the search result screen 820 in FIG. 8, the actual number of the entries of detailed information for the index word “port” contained in the content of English-Japanese dictionary B may be 4 or more, and the area 851 (see FIG. 10) of the detailed information screen 850 that is displayed when the “All” button 825 is pressed, may display all of the index words that includes index words that are not displayed on the search result screen 820 (for example, “port4”, etc.).

Note that when either an index word or “All” button is selected on the search result screen displayed on the display unit 403 of the electronic dictionary 4, the processes in Steps S301 to S303 in the detailed information displaying process illustrated in FIG. 9 are performed by the control unit 400 of the electronic dictionary 4 alone or in cooperation with the storage unit 401, display unit 403, etc.

As described above, in the search system 1 of an embodiment of the present invention, the index word list screen 810 generated based on the index word integrated search history 234 or 414, which is an aspect of index word search history, is displayed on the learning terminal 3 and electronic dictionary 4 as a search device. When the user of the search device selects an index word included in the index word list screen 810, the search device displays the search result screen 820 that includes information of dictionaries containing detailed information about the index word. Therefore, the user of the search device can easily confirm which dictionary was used to search for the index word searched in the past.

Note that the index word list screen generated and displayed based on the index word integrated search history 234 or 414 is not limited to the index word list screen 810 illustrated in FIG. 8. The index word list screen may be, for example, a screen in which only index words that have been searched frequently in the index word integrated search history 234 or 414 are extracted, or may include such a screen.

FIG. 11 is a diagram illustrating a second example of screen transitions when performing a search using an index word list generated based on the index word integrated search history. Although FIG. 11 illustrates screen transitions on the learning terminal 3, the screen transitions on the electronic dictionary 4 may be similar. In FIG. 11, the screen of the learning terminal 3 changes clockwise from a screen 800 shown at the top left.

The screen 800 of the learning terminal 3 at the top left may be a screen for selecting content of an English-Japanese dictionary, as described above with reference to FIG. 8. In the second example of the screen transitions described with reference to FIG. 11, a ranking-type index word list screen 840 illustrated in the learning terminal 3 at the top right is displayed when the item 803 of “learning log” is selected on the screen 800. In the following description, the ranking-type index word list screen 840 will be referred to as a second index word list screen 840, and the index word list screen 810 described above with reference to FIG. 8 will be referred to as a first index word list screen 810. The information displayed in a left side area 841 of the second index word list screen 840 is substantially the same as the information displayed in the left side area 801 of the screen 800. In a right side area 842 of the second index word list screen 840, the top 10 index words recorded in the index word integrated search history 234 listed in descending order of the number of searches are displayed in a ranking format that indicates respective ranks. Further, at the bottom of the area 842 of the second index word list screen 840, an item 844 for “View all logs” is displayed. When the item 844 for “View all logs” is selected, the first index word list screen 810 illustrated on the learning terminal 3 at the bottom right is displayed. When the index word displayed on the first index word list screen 810 (for example, the index word 815 “port”) is selected, the search result screen 820 illustrated on the learning terminal 3 at the bottom left is displayed. On the other hand, an index word displayed on the second index word list screen 840 is selected (for example, the index word 843 “port”, which ranks fifth in the order of search frequency), the search result screen 820 illustrated on the learning terminal 3 at the bottom left is displayed, instead of the first index word list screen 810. In this way, the index word list screen generated based on the index word integrated search history 234 or 413 is not limited to a screen with a specific display format.

The embodiments described above are specific examples to facilitate understanding of the invention, and the present invention is not limited to the embodiments described above. Various modifications and changes can be made to the search device, search system, search method, and program without departing from the scope of the claims.

For example, the search device (learning terminal 3 and electronic dictionary 4) and the Web system 2 in the search system 1 exemplified in the above-described embodiments may be connected to a communication network called a school LAN, intra-campus LAN, or the like, separate from the Internet 5.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A search device comprising a control unit performing the following:
causing a display unit to display a list of index words that have been previously used by a user to search for dictionary contents;
when the user selects an index word in the list of index words that are being displayed in the display unit, identifying one or more dictionary contents that contain detailed information for the selected index word from among contents of a plurality of types of dictionaries; and
causing the display unit to display a search result that includes information indicating the identified one or more dictionary contents and the selected index word associated with the detailed information in each of the identified one or more dictionary contents.

2. The search device according to claim 1, wherein, when the user selects the index word that is associated with a particular one of the identified one or more dictionary contents in the displayed search result, the control unit further causes the display unit to display the detailed information contained in the selected particular one of the identified one or more dictionary contents that is associated with the selected index word.

3. The search device according to claim 1, wherein the list of the index words is a list of index words generated based on a search history that combines the following:
a first search history including index words that the user of the search device has used to search for content of the first plurality of types of dictionaries using the search device;
a second search history including index words that the user has used to search for content of a second plurality of types of dictionaries using a search device that differs from the search device.

4. The search device according to claim 1, further comprising a storage unit that stores the contents of the plurality of types of dictionaries,
wherein the list of the index words is a list of index words generated based on a search history that combines a first index word search history including index words that the user has used to search for contents of a plurality of types of dictionaries that differ from the contents of the plurality of types of dictionaries stored in the storage unit using another search device that differs from the search device, and a second search history including index words that the user has used to search for the contents of the plurality of types of dictionaries stored in the storage unit.

5. A search system comprising a search device and a server communicably connected to the search device,
wherein a control unit of a search device causes a display unit to display a list of index words that have been previously used by a user to search for dictionary contents,
wherein when the user selects an index word in the list of index words that are being displayed in the display unit, the control unit of the search device sends the selected index word to the server,
wherein a control unit of the server performs the following:
identifying one or more dictionary contents that contain detailed information for the selected index word received from the search device from among contents of a plurality of types of dictionaries available through the server; and
sending a search result that includes information indicating the identified one or more dictionary contents and the selected index word associated with the detailed information in each of the identified one or more dictionary contents, and
wherein the control unit of the search device further causes the display unit of the search device to display the search result received from the server.

6. The search system according to claim 5, further comprising another search device as a second search device, said search device being referred to as a first search device, the first search device and the second search device existing independently of each other,
wherein the server further includes a first storage unit that stores contents of a first plurality of types of dictionaries, a first search history including index words that have been searched for by the user of the first search device, and user information associated with the user of the first search device and users of the second search device,
wherein the control unit of the server performs the following:
identifying one or more dictionary contents containing detailed information for the index word received from the first search device among the contents of the first plurality of types of dictionaries stored in the first storage unit; and
deriving a search result that includes information indicating the identified one or more dictionary contents and the selected index word associated with the detailed information in each of the identified one or more dictionary contents, and
sending the search result to the first search device;
wherein the second search device includes a second storage device that stores contents of a second plurality of types of dictionaries, and a second search history including index words that have been used to search for contents of the second plurality of types of dictionaries,
wherein a control unit of the second search device sends the second search history stored in the second storage unit to the server,
wherein the control unit of the server further performs the following:
receiving the second search history from the second search device; and
updating the first search history including the index words that have been searched by the user of the first search device based on the received second search history and the user information.

7. The search system according to claim 6, wherein the control unit of the server further performs:
generating the list of index words searched by the user of the first search device based on the first search history and sending the list to the first search device,
wherein the index word received from the first search device is an index word selected from the list by the user of the first search device.

8. A search method performed by a computer, comprising:
causing a display unit of the computer to display a list of index words that have been previously used by a user to search for dictionary contents;
when the user selects an index word in the list of index words that are being displayed in the display unit, identifying one or more dictionary contents that contain detailed information for the selected index word from among contents of a plurality of types of dictionaries; and
causing the display unit of the computer to display a search result that includes information indicating the identified one or more dictionary contents and the selected index word associated with the detailed information in each of the identified one or more dictionary contents.
